(19) United States
(12) Patent Application Publication
(10) Pub. No.: US 2026/0285213 A1
(43) Pub. Date: Sep. 24, 2026

(54) Adjustable Leg Support for a Car Seat

(71) Applicant: ARTSANA USA, INC., Lancaster, PA (US)

(72) Inventors: Michael L. LONGENECKER, Lancaster, PA (US); Michael S. DEGRACE, Red Lion, PA (US)

(21) Appl. No.: 19/083,939

(22) Filed: Mar. 19, 2025

(51) Int. Cl. B60N 2/90; B60N 2/28

(52) U.S. Cl. CPC B60N 2/995; B60N 2/2821; B60N 2/2869

(57) ABSTRACT

An adjustable leg support for a child's car seat provides for movement between a retracted configuration and an extended configuration. The car seat is configured to be selectively oriented for either forward-facing or rearward-facing use by a child occupant. The retracted configuration is suitable for use in either orientation while the extended configuration is suitable for use only in the forward-facing orientation. The adjustable leg support is further configured to angle a portion of the leg support in relation to a fixed portion of the seat to improve occupant comfort.

### FIELD OF THE INVENTION

The present disclosure is generally directed to child safety seats for use in vehicles, and more particularly to an adjustable leg support mechanism adapted for use with a rotatable child safety seat.

### BACKGROUND OF THE INVENTION

Safety seats in vehicles for children (car seats) are well-known in the art. Car seats are removable units that are secured to a selected passenger seat of a vehicle. Car seats are specially designed for the smaller weight and size of a child, as compared to standard vehicle seats, which are designed to accommodate large youths and adults. Most states have statutes requiring that children below certain age and/or weight limits be positioned in a rear-facing seat. Once the child reaches a certain weight and age a front-facing car seat may be used.

Conventional car seats are designed to secure a child and limit movement of the child which can make it difficult to move the child into or from such the seat. Car seats typically include partially raised sides and a five-point seatbelt harness to secure the child to the car seat. The raised sides make it necessary for an adult that is assisting the child into the seat to lift the child over a side of the seat and then place the child in the seat. Due to the confined space in most passenger vehicles, the adult must remain outside the vehicle when lifting the child and installing the five-point harness, causing the adult to bend and lean or reach into the vehicle. The same demands on the adult are required to remove the child from the car seat.

Recent car seat developments include designs featuring a rotatable seating portion attached to a stationary base which is secured to the vehicle. The seating portion may be rotated and locked into position to accommodate a child occupant in either a forward-facing or a rear-facing orientation. The seating portion may also be temporarily rotated to a side-facing orientation allowing a caregiver to access the child occupant face-to-face and improving care-giver access to child restraining belts and harnesses to ease the task of securing the child occupant in the seat or removing the child from the seat.

It is also common for car seats to include adjustable features to adapt the seating portion to comfortably fit a range of child occupant sizes, mainly as the child grows. Such features include vertically adjustable headrests, adjustable bolsters controlling the width of the seat, and extendable leg/thigh supports. Expanding the range of occupant sizes also requires consideration of structural capabilities to assure car seat crash integrity with larger and heavier occupants. Adjustable harness arrangements, interface between the car seat and the vehicle anchors, whether LATCH connections or vehicle safety belts, and structural reinforcement of the car seat must be collectively considered to assure child occupant safety during all phases of use for a complete range of child occupant weights and sizes. As more features and capabilities are incorporated into car seats, designs offering the require capability while also remaining easy to use become more challenging. The challenges are magnified on rotatable car seat designs which typically accommodate a broader range of child occupant weights/sizes and where adjustment features must fit within the space limitations imposed by rotating seat designs.

What is needed is a child seat that is adjustable to accommodate a range of sizes of child occupants, including forward-and rearward-facing orientations, while providing secure and an easy-to-use occupant restraint. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

In an aspect of the invention an adjustable leg support mechanism for a seat may allow a leg support to be moved between a retracted configuration and an extended configuration in relation to a fixed portion of the seat. The leg support may comprise a first portion and a second portion connected to the seat by a linkage controlling movement of the leg support. The first and second portions may be configured to generally align in the plane of the seat bottom when the leg support is in the retracted configuration. The first and second portions may be configured to be allow them to be angled relative to each other so that the forward end of the adjustable leg support angles downwardly when the leg support is in the extended configuration.

In an aspect of the invention an adjustable leg support mechanism for a seat may allow a leg support to be moved between a retracted configuration and an extended configuration in relation to a fixed portion of the seat. The leg support may comprise a first portion and a second portion. The leg support may include a first panel moveably connected to the seat by a first connection and a second connection, and a second panel moveably connected to the first panel by a third connection and a fourth connection. The first connection may comprise a rotating link pivotally connecting the seat and the first panel. The second connection may comprise a first follower fixed on the first panel engaging a first elongate guide fixed on the seat. The third connection may comprise a second elongate guide engaging a second follower fixed on the first panel. The fourth connection may comprise a third follower fixed on the second panel engaging the first elongate guide.

In an aspect of the invention an adjustable leg support mechanism for a seat includes a first panel moveably connected to the seat by first and second connections. The first connection may comprise a rotating link pivotally connecting the seat and the first panel. The second connection comprises a first follower fixed on the first panel engaging a first elongate guide fixed on the seat. The first elongate guide may be arcuate in form. The arcuate form may be convexly upward. The third connection comprises a second elongate guide engaging a second follower fixed on the first panel. The fourth connection comprises a third follower fixed on the second panel engaging the first elongate guide.

In an aspect of the invention an adjustable leg support mechanism for a seat includes a second panel moveably connected to a first panel by third and fourth connections. The third connection may comprise a second elongate guide engaging a second follower fixed on the first panel. The fourth connection may comprise a third follower fixed on the second panel engaging the first elongate guide. The second elongate guide may be linear in form along an axis. The linear axis of the second elongate guide may be angled in relation to the plane of a surface of the seat.

In an aspect of the invention an adjustable leg support for a rotatable car seat is moveable between a retracted configuration and an extended configuration in relation to a fixed portion of the car seat. The car seat is configurable to accommodate a child occupant in either a forward-facing or a rearward-facing orientation. The extended configuration increases the seat depth measured from the seat bite to a foreword end and may be limited to use when the car seat is in a forward-facing orientation. The additional seat depth increases comfort for larger child occupants. The retracted configuration of the leg support is usable with the car seat is installed in a rearward-facing orientation, suitable for smaller child occupants (e.g., infants). The retracted configuration may also be used in a forward-facing orientation.

In an aspect of the invention an adjustable leg support mechanism for a car seat may allow a leg support to be moved between a retracted configuration and an extended configuration in relation to a fixed portion of the seat. Movement of the leg support to the extended configuration may reconfigure the car seat to provide an alternative guide path for interface with a vehicle seat belt and allow the vehicle belt to secure a forward-facing child occupant in the car seat. Repositioning the leg support to the retracted configuration prevents access to the alternative guide path and inhibits the ability to secure the child occupant in the car seat using the vehicle seat belt. In the retracted configuration, the car seat harness arrangement is used to secure the child occupant in the car seat.

In an aspect of the invention an adjustable leg support mechanism for a rotatable car seat may allow a leg support to be moved between a retracted configuration and an extended configuration in relation to a fixed portion of the seat. The adjustable leg support mechanism may include a latching mechanism configured to enable selective release and movement of the leg support mechanism from either the extended configuration or the retracted configuration. The leg support mechanism may further be configured to reinforce the structure of the car seat in one or both use configurations.

In an aspect of the invention, a rotatable child car seat includes an adjustable leg support configured to allow the seat bottom length to be selectively adjusted without adversely affecting the function and ease of operation of the child restraint harness in the seat. The shoulder harness anchor points remain secured to the stationary portion of the seat shell and do not move with the adjustable leg support. A restraint harness release mechanism may be provided and include a plurality of release mechanism actuation points, at least one of which is accessible regardless of the extension position of the adjustable leg support or the rotational position of the rotatable car seat.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

FIG. 1 is a perspective view of an exemplar car seat of the type on which the present invention may be useful, the car seat shown configured to carry a child occupant in a forward-facing orientation;

FIG. 2 is a perspective view of the exemplar car seat of FIG. 1 shown configured to carry a child occupant in a rearward-facing orientation;

FIG. 3 is a perspective view of the exemplar car seat of FIG. 1 shown configured in a side-facing orientation as might be useful for placing a child occupant in or removing a child occupant from the car seat;

FIG. 4 is a perspective view of a seat shell assembly embodying aspects of the present invention shown in a first operational configuration;

FIG. 5 is a side elevation view of the seat shell assembly shown in FIG. 4;

FIG. 6 is a perspective view of the seat shell assembly of FIG. 4 shown in a second operational configuration;

FIG. 7 is a side elevation view of the seat shell assembly shown in FIG. 6;

FIG. 8 is a side elevation view of a seat shell assembly showing a seat extension assembly in a retracted configuration;

FIG. 9 is a side elevation of the seat shell assembly of FIG. 8 shown with the seat extension assembly in an extended configuration;

FIG. 10 is a partial view of the seat extension assembly of FIG. 8 showing a link and latching mechanism in the retracted configuration;

FIG. 11 is a partial view of the seat extension assembly of FIG. 9 showing a link and latching mechanism;

FIG. 12 is a partial perspective view of a seat extension assembly showing seat panels and connections in a retracted configuration;

FIG. 13 is a partial perspective view of a seat extension assembly showing seat panels and connections in a retracted configuration;

FIG. 14 is a partial view of a seat extension assembly viewed from below showing the panel connections;

FIG. 15 is a partial perspective view of a first panel of the seat extension assembly of FIG. 14;

FIG. 16 is a partial perspective view of a second panel of the seat extension assembly of FIG. 14;

FIG. 17 is a partial perspective view of a s seat shell with a seat extension assembly shown in a retracted configuration;

FIG. 18 is a partial perspective view of a s seat shell with a seat extension assembly shown in an extended configuration;

FIG. 19 is a partial front view of a s seat shell with a seat extension assembly shown in a retracted configuration; and

FIG. 20 is a partial front view of a s seat shell with a seat extension assembly shown in an extended configuration.

Wherever possible, the same reference numbers will be used throughout the drawings to represent the same parts.

### DETAILED DESCRIPTION OF THE INVENTION

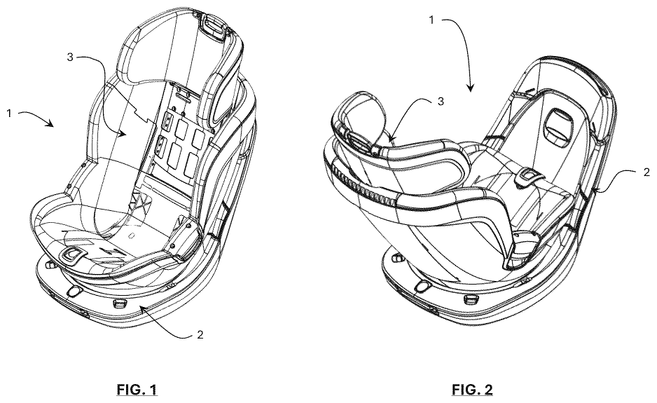

In FIGS. 1 through 3, there is illustrated an exemplar child car seat 1 including a base assembly 2 and a seat shell assembly 3. The car seat 1 is configured to be positioned and secured on the seating surface of a vehicle seat. Vehicle seat belts may be used to secure the base assembly 2 in position. Alternatively, the base assembly 2 may be secured to the vehicle seat using Lower Anchors and Tethers for Children (LATCH) anchoring provisions that may be present in the vehicle. In either installation, the seat shell assembly 3 connection to the base assembly 2 is configured to maintain the seat shell assembly securely connected to the base assembly and therefore to the vehicle in all use modes.

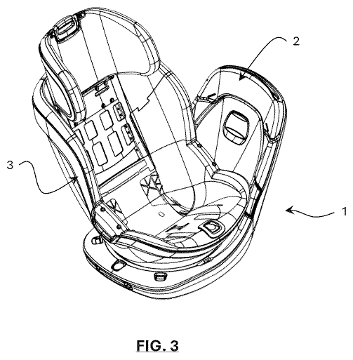

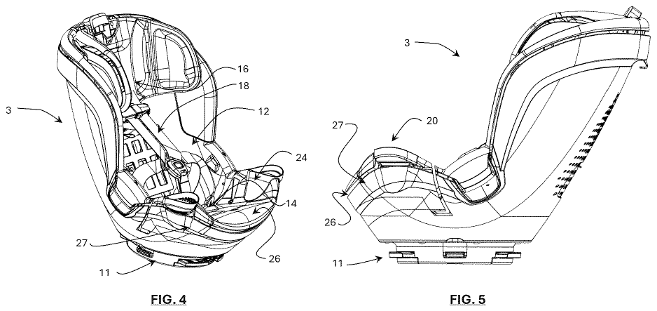

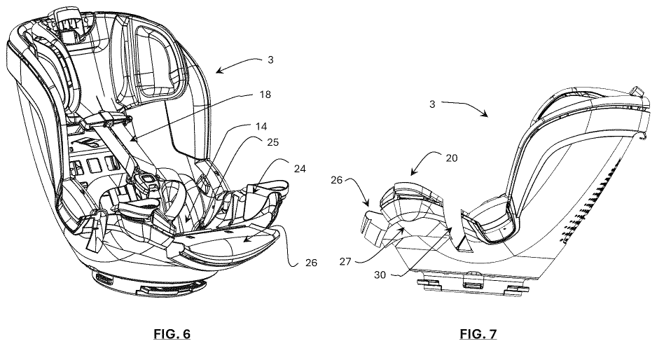

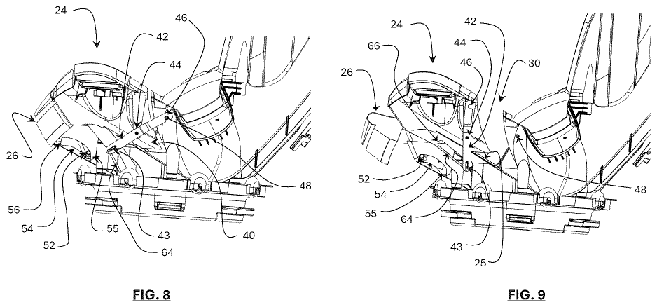

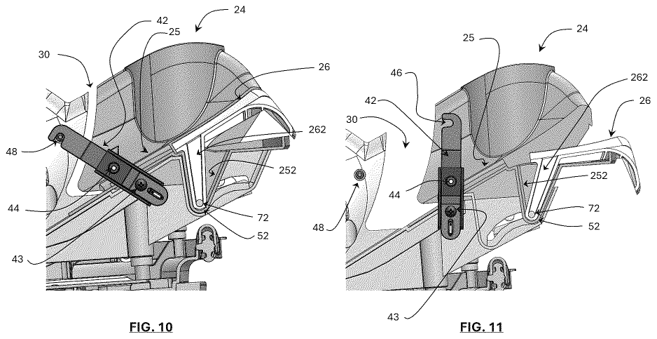

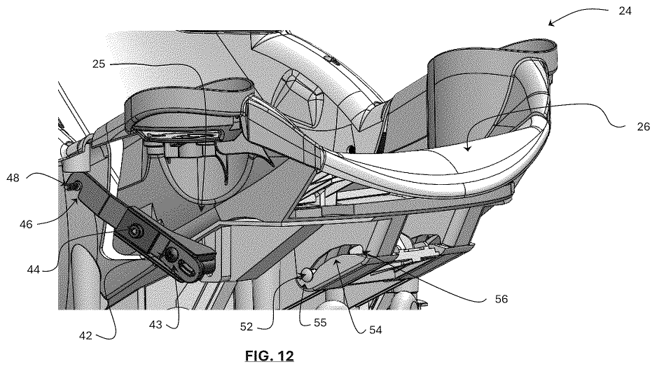

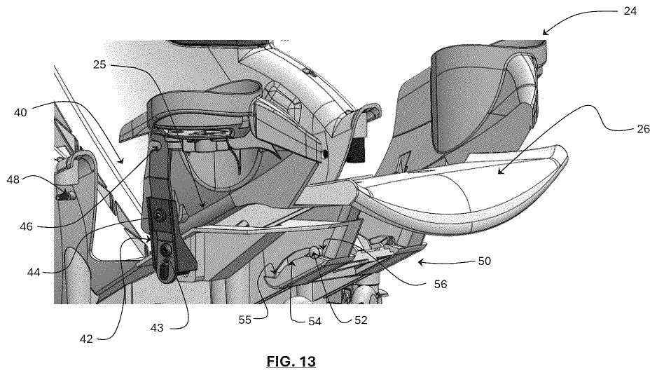

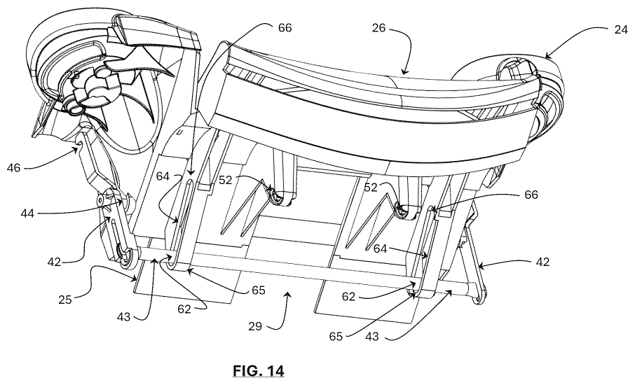

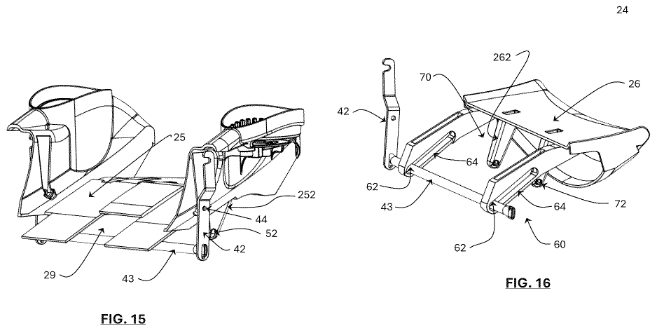

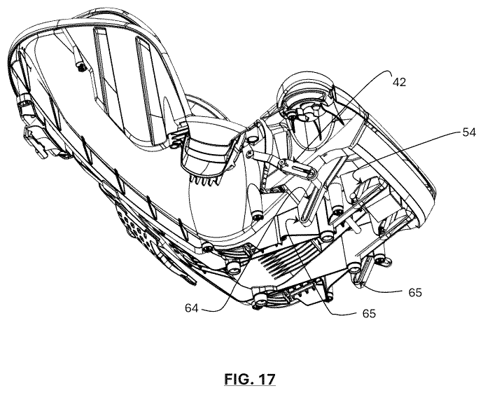

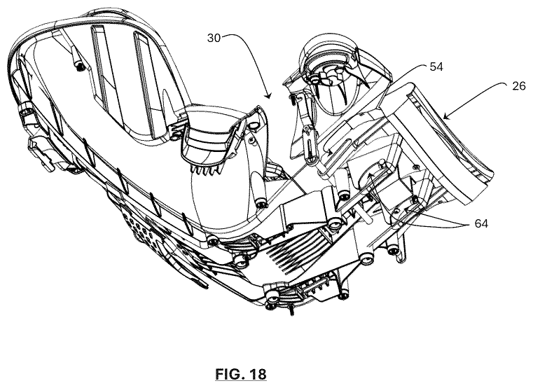

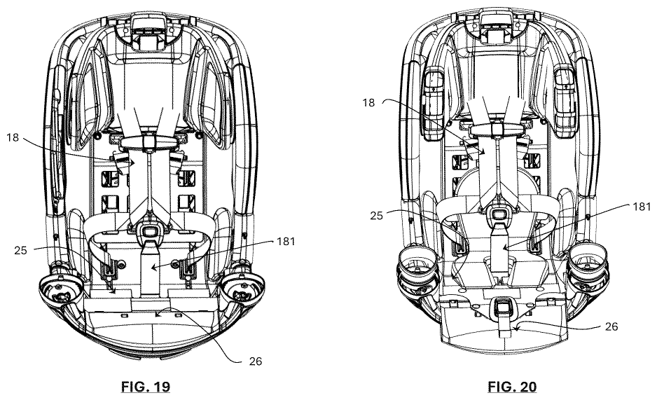

In FIGS. 4 and 5, the exemplar seat shell assembly 3 is shown including a connector 11 for attachment to a seat base assembly, the connector enabling the seat shell assembly to rotate about a generally upright axis to position the seat shell assembly in forward-facing (FIG. 1), rearward-facing (FIG. 2), or side-facing orientations (FIG. 3). The seat shell assembly 3 includes an interior space 12 defining a seating portion 14 and a backrest portion 16 configured to receive a child occupant. A harness assembly 18 may be provided to secure a child occupant within the interior space. The seat shell connection to the base assembly enables the base to be securely anchored into a vehicle using Lower Anchors and Tethers (LATCH), the vehicle safety belts, or a combination thereof. By anchoring the base assembly to the vehicle and assuring structural capabilities in both the base and seat shell assemblies, the seat shell may be used in forward-or rearward-facing orientations with the child occupant secured in the seat shell assembly by harness belts within the seat shell assembly. The seat shell assembly may be as disclosed in U.S. Pat. No. 11,584,267, Rotatable Car Seat with Detachable Seat and Top Anchor, the descriptive portions of which are incorporated by reference herein.

The seat shell assembly may be configurable to accommodate larger child occupants. To this end a seat extension assembly 20, also referred to as an adjustable leg support assembly, comprising an extensible portion 24 of the seating surface 14 with a surrounding shell structure 27 may be provided. The seating surface extensible portion 24 is configured to enable the seat surface 14 to be selectively adjusted to alter the effective depth (seat bite to forward end) of the seat. The seat extension assembly is selectively moveable between opposing forward (extended) (FIGS. 3 & 4) and rearward (retracted) positions (FIGS. 1 & 2). Movement of the seat extension assembly 20 actuates an extension assembly mechanism to alter the depth of the car seat bottom to tailor leg support for the child occupant and improve comfort. Rotational movement of the seat shell assembly 3 about the base assembly is inhibited by interaction between the extended seat extension assembly and the adjacent base assembly structure at the rearward portions of the assembled seat unit. The car seat is limited to forward-facing use when the seat extension assembly is in the extended configuration. Retracting the seat extension assembly allows rotational movement of the seat shell in relation to the base assembly and enable use of the car seat in either forward-facing or rearward-facing orientations.

Movement of the seat extension assembly 20 forwardly to the extended position does not affect the anchorage of the integrated safety harness belts 18 provided in the seat shell. The seat extension assembly 20 may be contoured to permit extension and retraction without contacting the safety harness belts. Seat extension assembly 20 forward movement to the extended position does, however, alter the configuration of the seat shell in a manner allowing vehicle safety belts to interface with the seat shell in a manner allow the vehicle safety belts to secure the child occupant in the seat in lieu of or in addition to the safety harness integrated in the seat shell assembly. When extended, a guide path 30 is opened in the seat shell to receive the vehicle safety belt and allow it to be used to restrain the child occupant. This configuration is suitable for forward-facing occupant use only. The safety seat may be secured to base assembly which is secured to the vehicle by LATCH anchors as described above. Using or including the vehicle safety belts to retrain the child occupant reduces the structural requirements imposed on the seat shell backrest portion 16, allowing the car seat assembly to be rated to accommodate larger (heavier) child occupants.

Retracting the seat extension assembly closes the guide path 30 for the vehicle safety belt and shortens the depth of the seating surface making the car seat better suited for smaller child occupants (e.g., infants).

The seat extension assembly 20 comprises a moveable extension portion 24 with an extension mechanism. The moveable extension portion 24 may comprise a first panel 25 and a second panel 26. The first and second panels are preferably moveable relative to each other to allow the contour of the seat to be altered dependent upon the position of the seat extension assembly 20. The first panel 25 may be configured to remain generally aligned in the plane of the fixed portion of the seating surface 14 as the seat extension assembly moves between extended and retracted configurations. The first and second panels 25, 26 may be configured to generally align in the plane of the fixed seating surface bottom when the seat extension assembly is in the retracted configuration. The second panel 26 may be angled downwardly as the seat extension assembly 20 is moved toward the extended configuration. Soft goods may be provided to cover the panels and limit prevent

First panel 25 of the seat extension assembly is connected to the seat shell structure by the extension mechanism comprising a pair of connections 40, 50 which control its movement as the seat extension assembly is repositioned. A first connection 40 may comprise a link 42 that pivotally interconnects the seat shell assembly 3 and the first panel 25. The link 42 may be connected to the seat shell by a rotatable rod 43 extending transverse to the seat shell assembly. The link 42 may be connected to the first panel at a pivot pin 44. The first and second connections 40, 50 may generally emulate a parallel linkage which retains the orientation of the upfacing seating surface of the primary extension portion generally coplanar with the fixed portion of the seating surface during seat extension assembly movement.

The link 42 may further comprise a catch 46 which is engageable on an anchor 48 on the seat shell assembly. The catch 46 may be displaced from the pivot pin 44. The link 42 and the catch 46 may be configured so that rotation of the link caused by retracting movement of the seat extension assembly engages the catch on the anchor 48. When so engaged, the link 72 reinforces the connection between the seat extension assembly and the seat shell assembly.

A second connection 50 for the first panel 25 may include a first follower 52 connected to the first panel 25 engaging an elongate first guide slot 54 in the seat shell assembly. First guide 54 may be an elongate slot-like opening into which the first follower 52 is received in a manner allowing the follower to move in the slot between its endpoints 55, 56. Movement of the first follower 52 between the endpoints 55, 56, generally corresponds to movement of the seat extension assembly between the extended and retracted configurations. Movement of the first follower 52 may be constrained to bi-directional motion between the endpoints 55, 56. The first guide 54 may be generally linear between the endpoints or it may be contoured to manage movement of the follower and its connected first panel. In an embodiment, the first guide slot 54 is arcuately shaped and convexly oriented upwardly.

Second panel 26 of the seat extension assembly is connected to the seat shell assembly by the extension mechanism further comprising a pair of connections 60, 70 which control its movement relative to the first panel 25 as the seat extension assembly is repositioned. A third connection 60 may comprise a second guide 64 disposed on the second panel for movement therewith, the second guide being engaged by a second follower 62 fixed on the seat shell assembly. The second guide 64 may be an elongate slot-like opening into which the second follower 62 is received in a manner allowing the follower to move in the slot between its endpoints 65, 66. Movement of the second follower 62 between the endpoints 55, 56, generally corresponds to movement of the seat extension assembly between the extended and retracted configurations. Movement of the second follower 62 may be constrained to bi-directional motion between the endpoints 65, 66. The second guide 64 may be generally linear between the endpoints or it may be contoured to manage movement of the follower and its connected second panel. The second guide 64 may be angled in relation to the plane of the second panel to further manage motion of the second panel. The second follower 62 may be co-axial with the rotatable rod 43. The second follower 62 may be the rotatable rod 43.

A fourth connection 70 joining the second panel to the seat shell assembly may comprise a third follower 72 that pivotally engages the first guide 54 first on the seat shell assembly. The third follower 72 moves generally bi-directionally between endpoints 55, 56 in the first guide 54 as the seat extension assembly moves between the extended and retracted configurations. The third follower 72 and the first follower 52 may be linked for simultaneous movement in the first guide 54. The third follower 72 and the first follower 52 may comprise a coaxial pivoting connection such as an axle or rolling element engaged in the first guide 54. The first follower 52 and the third follower 72 are preferably configured to allow to allow relative coaxial pivoting movement of the first and second panels about an axis on which the followers are coaxially aligned in additional to the translatory movement between the endpoints 55, 56 of the first guide 54.

The first and second connections 45, 50 for the first panel 25 and the third and fourth connections 60, 70 for the second panel 26 may be mirrored to provide connections and interfaces on both transverse sides of the seat extension assembly. The rotatable rod 43 about which the link 42 pivots may extend laterally transverse to the seat extension assembly and allow a second link to be provided on the opposite side of the seat, its rotational movement coordinated with the first link 42 movement. The first and second guides 54, 64 may comprise a mirror pair of slot-like openings, or two separate and laterally spaced-apart guides may be employed in each connection.

The interface between the first panel 25 and the second panel 26 may be configured to limit the angular movement of second panel 26. In an embodiment, second panel 25 may include an extension leg 262 which supports third follower 72 and may be positioned within a receptacle 252 formed in first panel, the receptacle extending proximate to first follower 52 and internally configured to limit the pivoting movement of the extension leg about an axis extending through third follower 72.

A locking mechanism may be provided to retain the seat extension assembly in at least the extended and retracted positions. An actuator for the locking mechanism is conveniently accessible by a user when interfacing with the seat extension assembly to reposition. The locking mechanism may comprise one or more sliding pins engageable in the link 42, which when engaged prevent rotation of the link 42. The sliding pins may be transversely arranged. Separate sliding pins may be provided to provide the locking function in the extended and retracted configurations. Alternatively, the link 42 may be configured to allow a single or pair of pins to engage openings in the link corresponding to the configuration of the seat extension assembly. The pins may be biased into engagement with an opening on the link; moving the pin against the biasing forces disengages the pin from the link and allows the link 42 to rotate.

The seat extension assembly may be configured to allow access to a harness release for the harness assembly 18. A gap or opening 29 may be provided in the first panel 25 to provide clearance to allow retracting movement of the seat extension assembly without contacting the seat harness 18. Access to the harness release is preferably unaffected by positioning of the seat extension assembly. Soft goods covering the seat may be provided with an access opening to permit user access to the harness release. The soft goods may include a barrier to prevent debris intrusion into the harness release or the harness adjusting mechanism.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. An adjustable leg support mechanism for a child seat comprising:
a seat shell;
a first panel moveably connected to the seat shell by a first connection and a second connection; and
a second panel moveably connected to the first panel by a third connection and a fourth connection;
wherein the first connection comprises a link connecting the seat shell and the first panel, and the second connection comprises a first follower fixed on the first panel engaging a first elongate guide on the seat shell; and
wherein the third connection comprises a second elongate guide engaging a second follower fixed on the seat shell, and the fourth connection comprises a third follower fixed on the second panel engaging the first elongate guide.

2. The adjustable leg support mechanism of claim 1, wherein the first elongate guide is arcuately shaped.

3. The adjustable leg support mechanism of claim 1, wherein the second elongate guide is linearly shaped.

4. The adjustable leg support mechanism of claim 1, wherein the second follower is disposed at the link connection to the first panel.

5. The adjustable leg support mechanism of claim 1, wherein the first follower and the third follower comprise a coaxial pivoting connection.

6. The adjustable leg support mechanism of claim 1, wherein the link further comprises a catch, the catch engaging the seat shell when the leg support mechanism is in a retracted configuration.

7. The adjustable leg support mechanism of claim 1, wherein the first follower and the third follower comprise a coaxial pivoting connection.

8. An adjustable leg support for a child car seat comprising:
a seat shell including a seating surface;
a moveable leg support further comprising:
a first leg support portion moveably connected to the seat shell by a first connection and a second connection; and
a second leg support portion moveably connected to the first leg support portion by a third connection and a fourth connection, the moveable leg support moveable in relation to the seating surface between opposing retracted and extended configurations;
wherein leg support movement toward the extended configuration increases a forward-rearward dimension of the car seat and angles the second leg support portion relative to the first leg support portion; and
wherein leg support movement toward the retracted configuration decreases the forward-rearward dimension of the car seat and aligns the first leg support portion, the second leg support portion and the seating surface.

9. The adjustable leg support of claim 8, wherein leg support movement toward the extended configuration creates a guide path to allow use of a vehicle safety belt to secure a child occupant in the car seat.

10. The adjustable leg support of claim 8, wherein the first connection comprises a link connecting the seat shell and the first leg support portion, and the second connection comprises a first follower fixed on the first leg support portion engaging a first elongate guide on the seat shell, and wherein the third connection comprises a second elongate guide engaging a second follower fixed on the first leg support portion, and the fourth connection comprises a third follower fixed on the second leg support portion engaging the first elongate guide.

11. The adjustable leg support of claim 10, wherein the link further comprises a catch engageable on an anchor disposed on the seat shell, the catch engaging the post anchor the leg support is in the retracted configuration.

12. The adjustable leg support of claim 10, wherein the first elongate guide is arcuately shaped.

13. The adjustable leg support of claim 10, wherein the second elongate guide is linearly shaped.

14. The adjustable leg support of claim 10, wherein the second follower is disposed at the link connection to the first panel.

15. The adjustable leg support of claim 10, wherein the first follower and the third follower comprise a coaxial pivoting connection.

16. An adjustable leg support for a child car seat comprising:
a base assembly securable in a vehicle;
a seat shell including a seating surface, the seat shell moveably connectable to the base assembly in at least a forward-facing and a rearward-facing orientation;
a moveable leg support further comprising:
a first leg support portion moveably connected to the seat shell by a first connection and a second connection; and
a second leg support portion moveably connected to the first leg support portion by a third connection and a fourth connection, the moveable leg support moveable in relation to the seating surface between opposing retracted and extended configurations;
wherein leg support movement toward the extended configuration increases a forward-rearward dimension of the car seat and prevents movement of the seat shell to the rearward-facing orientation; and
wherein leg support movement toward the retracted configuration decreases the forward-rearward dimension of the car seat and enables movement of the seat shell to either the forward-facing or rearward-facing orientation.

17. The adjustable leg support of claim 16, wherein leg support movement toward the extended configuration angles the second leg support portion relative to the first leg support portion, and wherein leg support movement toward the retracted configuration aligns the first leg support portion, the second leg support portion and the seating surface.

18. The adjustable leg support of claim 16, wherein leg support movement toward the extended configuration creates a guide path to allow use of a vehicle safety belt to secure a child occupant in the child car seat.
